(19) United States
(12) Patent Application Publication
(10) Pub. No.: US 2012/0156383 A1
(43) Pub. Date: Jun. 21, 2012

(54) Graffiti Deterrent Coating

(76) Inventor: Timothy S. Walsh, Arvada, CO (US)

(21) Appl. No.: 12/968,909

(22) Filed: Dec. 15, 2010

(51) Int. Cl. C09D 129/04; B05D 3/00

(52) U.S. Cl. 427/387; 524/503

(57) ABSTRACT

A graffiti deterrent coating includes water, polyvinyl alcohol, silicone resin emulsion paint, and polytetrafluoroethylene. The coating is non-sacrificial and is resistant to paint applied over the coating, causing the paint to bead and run rather than to adhere to the coating.

### BACKGROUND

Exterior surfaces in public places are often targets for graffiti. Even though some consider graffiti to be an art form, most consider it to be vandalism and the removal of graffiti is usually desired. Graffiti is often applied with spray paint, which is usually oil-based. Oil-based paint is difficult to remove from surfaces and is often sandblasted or scrubbed off with solvents, which may be hazardous. Both of these methods of removal may be costly.

### DETAILED DESCRIPTION

In one embodiment of the present invention a graffiti deterrent coating includes water, polyvinyl alcohol, silicone resin emulsion paint, and polytetrafluoroethylene. Together, these materials cooperate to form a coating that is non-sacrificial and is resistant to paint applied over the coating. Paint applied over the coating beads and runs rather than adhering to the coating.

A graffiti deterrent coating may be sacrificial, semi-permanent, or permanent (non-sacrificial). A sacrificial coating typically uses a wax-like substance that is applied to the surface to be protected. After the surface has been marked with graffiti, a hot water blaster may be used to remove the graffiti. Over time, the sacrificial product usually breaks down, turns yellow, and must be removed and reapplied, which is time-consuming and expensive.

A semi-permanent coating also provides a temporary solution. Often, these products have a light sheen, compromising the aesthetics of the original structure and causing glare, which can be dangerous in traffic areas. These coatings can sustain a small number of graffiti cleanings. After a few graffiti cleanings, semi-permanent products erode, requiring removal and reapplication.

Once applied, a permanent or non-sacrificial coating provides unlimited graffiti removal over the lifetime of the product. Depending on the climate and placement of product, the product lifetime can last from nine months to two years. The harsher the climate, the shorter the product life.

It is anticipated that any type of water may be used for the coating. However, in one embodiment, the water of the coating is distilled water. It has been found that the most effective amount of water is between about 81% and about 85% by volume. After the coating is applied, much of this water evaporates, leaving the remaining materials behind to provide the graffiti deterrent result.

Polytetrafluoroethylene (PTFE) is a synthetic fluoropolymer of tetrafluoroethylene. PTFE is most well known by the brand name Teflon®. In one embodiment, the polytetrafluoroethylene is a clear liquid polytetrafluoroethylene. It has been found that the most effective amount of polytetrafluoroethylene is between about 2.5% and about 6.5% by volume.

In one embodiment, the silicone resin emulsion paint is a clear silicone resin emulsion paint. It has been found that the most effective amount of silicone resin emulsion paint is between about 1% and about 5% by volume.

In one embodiment, the coating further includes a light stabilizer. A light stabilizer filters harmful UV light and traps free radicals once they are formed. One example of such a light stabilizer is Tinuvin® DW. It has been found that the most effective amount of light stabilizer is between about 0.5% and about 3.5%.

Polyvinyl alcohol is a water-soluble synthetic polymer. Polyvinyl alcohol is commonly available in powder and pellet forms. It has been found that the most effective amount of polyvinyl alcohol is between about 6% and about 10% by volume.

In one embodiment, the graffiti deterrent coating is produced by heating the water to 195 degrees Fahrenheit. Polyvinyl alcohol pellets are added to the heated water and dissolved as the water cools. The polyvinyl pellets dissolve at temperatures from 190 to 200 degrees. At cooler temperatures, the pellets tend to clump and possibly not dissolve adequately. At higher temperatures, the polyvinyl alcohol begins to take on an unpleasant smell. Although the coating still functions properly, the unsavory smell is undesirable. After the combination cools to less than 100 degrees Fahrenheit, the light stabilizer, silicon resin emulsion paint, and PTFE are added. The result is agitated to combine the materials thoroughly.

Once the coating cools, it me be applied to a surface to be protected. In one embodiment of the present invention, a surface is protected from graffiti by applying to the surface a graffiti deterrent coating as described above and allowing the coating to dry. The coating is non-sacrificial and is resistant to paint applied over the coating, causing the paint to bead and run rather than to adhere to the coating.

The present invention graffiti deterrent coating has several advantages over conventional graffiti deterrent coatings. It contains no hazardous materials such as isocyanate, triethanolamine, and triethylene glycol, and releases only very small amounts of volatile organic compounds. Since it contains no hazardous material, no special protective equipment or respirators are required when applying the coating to surfaces.

The coating is non-sacrificial and not wax based. Wax based coatings sometimes melt and run off surfaces heated by the sun.

The coating acts as a graffiti deterrent and not merely as a protective coating which allows graffiti to be easily clean from surfaces. The coating deters graffiti because when attempts are made to paint protected surfaces, the paint beads and runs, rather than adhering. When the paint does not adhere properly to the surface to allow the graffiti to appear as the graffiti artist desires, graffiti artists may be discouraged from further acts. Paint applied to protective surfaces may also be easily cleaned with water. No detergent or paint solvent is required.

The coating has the added advantage of not diminishing reflective surfaces, such as present on road signs. This is an advantageous quality as road signs may be protected with the coating without reducing the safety features of the signs.

Furthermore, the coating may be tinted as desired or needed. The tint is added to the coating while it is prepared. Once the coating is applied and dry, the tint is sealed into the coating.

Once prepared, the coating is relatively stable, with a long shelf life. The coating does not harden or yellow over time in storage.

In addition, the coating may be removed at any time with a heated pressure washer. The water in the pressure washer is heated to 180 degree Fahrenheit and used to remove the coating from the protected surface.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A graffiti deterrent coating comprising: water, polyvinyl alcohol, silicone resin emulsion paint, and polytetrafluoroethylene, wherein the coating is non-sacrificial and is resistant to paint applied over the coating, causing the paint to bead and run rather than to adhere to the coating.

2. The coating of claim 1 wherein the water is distilled water.

3. The coating of claim 1 wherein the polytetrafluoroethylene is a clear liquid polytetrafluoroethylene.

4. The coating of claim 1 wherein the silicone resin emulsion paint is a clear silicone resin emulsion paint.

5. The coating of claim 1 further including a light stabilizer.

6. The coating of claim 1 wherein the polyvinyl alcohol is present in the coating in the range of about 6% to about 10% by volume, the silicone resin emulsion paint is present in the coating in the range of about 1% to about 5% by volume, and the polytetrafluoroethylene is present in the coating in the range of about 2.5% to about 6.5% by volume.

7. The coating of claim 7 wherein the water is present in the coating in the range of about 81% to about 85% by volume.

8. The coating of claim 7 further including a light stabilizer present in the coating in the range of from about 0.5% to about 3.5%.

9. A method for protecting a surface from graffiti, the method comprising:
applying to the surface, a graffiti deterrent coating comprising water, polyvinyl alcohol, silicone resin emulsion paint, and polytetrafluoroethylene;
allowing the coating to dry; and
wherein the coating is non-sacrificial and is resistant to paint applied over the coating, causing the paint to bead and run rather than to adhere to the coating.

10. The method of claim 11 wherein the water is distilled water.

11. The method of claim 11 wherein the polytetrafluoroethylene is a clear liquid polytetrafluoroethylene.

12. The method of claim 11 wherein the silicone resin emulsion paint is a clear silicone resin emulsion paint.

13. The method of claim 11 wherein the coating further includes a light stabilizer.

14. The method of claim 11 wherein the polyvinyl alcohol is present in the coating in the range of about 6% to about 10% by volume, the silicone resin emulsion paint is present in the coating in the range of about 1% to about 5% by volume, and the polytetrafluoroethylene is present in the coating in the range of about 2.5% to about 6.5% by volume.

15. The method of claim 17 wherein the water is present in the coating in the range of about 81% to about 85% by volume.

16. The method of claim 17 wherein the coating further includes a light stabilizer present in the coating in the range of from about 0.5% to about 3.5%.
